(19) United States
(12) Patent Application Publication
(10) Pub. No.: US 2023/0315024 A1
(43) Pub. Date: Oct. 5, 2023

(54) COUNTING TIMEPIECE DEVICE

(71) Applicant: ROLEX SA, Geneva (CH)

(72) Inventors: Pierre-Alain Graemiger, Trelex (CH); Ludovic Zbylut, Seynod (FR)

(73) Assignee: ROLEX SA, Geneva (CH)

(21) Appl. No.: 18/191,014

(22) Filed: Mar. 28, 2023

(30) Foreign Application Priority Data
Mar. 30, 2022 (EP) 22165613.5

(51) Int. Cl. G04F 7/08

(52) U.S. Cl. CPC G04F 7/0809; G04F 7/0857; G04F 7/0861

(57) ABSTRACT

A method for operating a counting device (90), such as a countdown device, or a timepiece movement (100) or a timepiece (200), the method including performing a first action on a first control member (C1) causing a first timepiece function to be returned to an initial state, and then performing a second action on the first control member (C1) causing an action of adjusting or winding a second timepiece function.

This application claims priority of European patent application No.

EP22165613.5 filed Mar. 30, 2022, the content of which is hereby incorporated by reference herein in its entirety.

### BACKGROUND ART

The invention relates to a counting timepiece device. The invention also relates to a timepiece movement comprising such a counting device. The invention also relates to a timepiece comprising such a timepiece movement or such a counting device. The invention lastly relates to a method for operating such a counting device or such a timepiece movement or such a timepiece.

Various prior art documents set forth solutions for actuating multiple separate functions with one and the same control means, such as a chronograph pushbutton. However, all of these solutions require an additional action and/or interface that make(s) it possible to preconfigure said control means so as to act on one or the other of the functions.

Document EP1777598 discloses a programmable countdown mechanism which has a counting device. This design is provided with a first control means for returning the countdown to the starting position, a second, “start/stop” control means, a control stem and an additional control member. The countdown can be programmed by the control stem as long as the control means for returning to the starting position is kept in a pressed position by the additional control member.

Document EP2453322 describes a chronograph movement comprising two conventional chronograph control means and a correction mechanism provided with a control stem. When the control stem is in a different position than that corresponding to a first position, one of the two chronograph control means makes it possible to correct a variable associated with time instead of acting on the chronograph. In other words, this solution uses one and the same control means to actuate the chronograph in a first position of the control stem and to correct another variable associated with time in another position of the control stem that differs from the first position.

The solution proposed in document EP2955590 discloses a mono-pushbutton chronograph (with three cycles) provided with a “flyback” function. The chronograph and the “flyback” are controlled by a single control means taking the form of a stem which is able to be actuated in translational and rotational movement. This stem notably acts as a pushbutton for controlling the chronograph and the “flyback”. The rotation of this stem notably makes it possible to switch the pushbutton function so as to control either the chronograph or the “flyback”.

### SUMMARY OF THE INVENTION

The object of the invention is to provide a timepiece movement that improves the timepiece devices known from the prior art. In particular, the invention proposes a timepiece movement having a countdown mechanism which is practical and ergonomic to use.

According to the invention, a method is defined by point 1 below.

1. A method for operating a counting device, such as a countdown device, or a timepiece movement or a timepiece, the method comprising:
a first action on a first control member causing a first timepiece function to be returned to an initial state, and then
a second action on the first control member causing an action of adjusting or winding a second timepiece function.

Embodiments of the method are defined by points 2 to 11 below.

2. The operating method as defined in the preceding point, wherein the first timepiece function and the second timepiece function are one and the same timepiece function.

3. The operating method as defined in point 1 or 2, wherein the first function is a timing function or a chronograph function, in particular a countdown function.

4. The operating method as defined in one of the preceding points, wherein the adjusting or winding action is an incremental and/or sequential action.

5. The operating method as defined in one of the preceding points, wherein any second action on the first control member while the first timepiece function is returned to an initial state causes an action of adjusting or winding the second timepiece function.

6. The operating method as defined in one of the preceding points, wherein the first action is a pressing action on the first control member and/or wherein the second action is a pressing action on the first control member.

7. The operating method as defined in one of the preceding points, wherein third actions, notably third pressing actions, on a second control member cause the first timepiece function to be sequentially activated and deactivated.

8. The operating method as defined in one of the preceding points, wherein the first timepiece function is a chronograph function, in particular a countdown function, displaying a first item of information, notably minutes information, and a second item of information, notably seconds information, and wherein a fourth action, notably a fourth pressing action, on the first control member while the first timepiece function is in an activation state causes the display of the second information to return to an initial state and the display of the first information to be set to the closest full item of information.

9. The operating method as defined in one of the preceding points, wherein the first action causes:
a control lever to pivot,
the pivoting of the control lever causing a hammer to act on a mobile for returning to the starting position, notably by the hammer pivoting,
the hammer releasing a locking lever such that the latter is placed in a position (i) of locking the hammer in a position in which it interacts with the mobile for returning to the starting position and releases an incrementing pawl.

10. The operating method as defined in the preceding point, wherein the second action causes:
the control lever to pivot,
the control lever causing the incrementing pawl to move such that the latter interacts with an incrementing mobile in order to make said incrementing mobile rotate by one pitch.

11. The operating method as defined in points 9 or 10 and as defined in point 7, wherein, while the first timepiece function is in an initial state, a third action causes:
a control cam, notably a column wheel, to rotate by one pitch,
the rotation of the control cam causing the locking lever to pivot such that the latter is placed in a position (ii) in which it unlocks the hammer and deactivates the incrementing pawl,
the unlocking of the hammer causing the hammer to return to a position in which it does not interact with the mobile for returning to the starting position.

According to the invention, a counting device or a timepiece movement is defined by point 12 below.

12. A counting device or timepiece movement comprising hardware means arranged and configured to implement the operating method as defined in one of the preceding points.

Embodiments of the counting device or of the timepiece movement are defined by points 13 and 14 below.

13. The counting device or timepiece movement as defined in the preceding point, wherein the hardware means comprise:
a first control member,
a second control member,
a control cam, notably a column wheel,
an incrementing pawl,
a hammer,
a locking lever,
a mobile for returning to the starting position, and
an incrementing mobile.

14. The counting device or timepiece movement as defined in the preceding point, wherein the hardware means comprise a control lever and wherein the first control member interacts with the control lever that is able to act on the hammer and on the incrementing pawl and/or wherein the second control member is arranged so as to act on the control cam.

According to the invention, a timepiece is defined by point 15 below.

15. A timepiece, in particular wristwatch, comprising a counting device or a timepiece movement as defined in one of points 12 to 14.

### BRIEF DESCRIPTION OF THE DRAWINGS

The appended drawings show, by way of example, one embodiment of a timepiece according to the invention.

FIG. 1 is a view of one embodiment of a timepiece according to the invention.

FIG. 2 is a diagram illustrating the operation of the embodiment of the timepiece.

FIG. 3 is an exploded perspective view of an exemplary embodiment of a programming mobile.

FIG. 4 is a view of the embodiment of the timepiece in a configuration at the start of the countdown.

FIG. 5 is a view of the embodiment of the timepiece in a countdown configuration.

FIG. 6 is a view of the embodiment of the timepiece in a stop configuration of the countdown.

FIG. 7 is a view of the embodiment of the timepiece in a configuration or state of resetting the countdown.

FIG. 8 is a view of the embodiment of the timepiece in a reset configuration or reset state of the countdown.

FIG. 9 is a view of the embodiment of the timepiece in a countdown programming configuration, with an adjusting action being exerted.

FIG. 10 is a view of the embodiment of the timepiece in another countdown programming configuration, with no adjusting action being exerted.

FIG. 11 is a view of the embodiment of the timepiece in a configuration at the end of the countdown.

FIG. 12 is a view of the embodiment of the timepiece in a countdown correction configuration.

### DETAILED DESCRIPTION OF PARTICULAR EMBODIMENTS

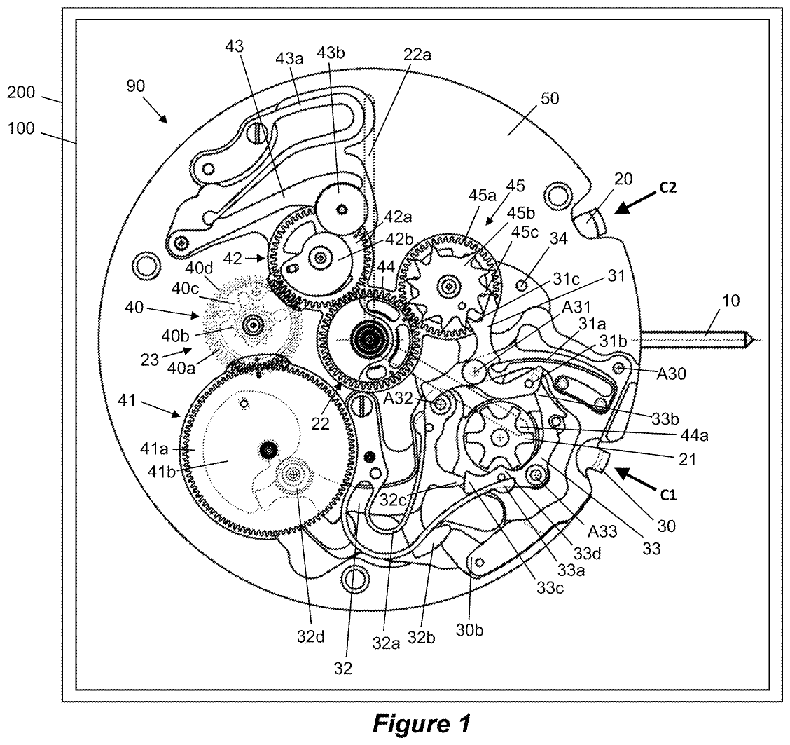

One embodiment of a timepiece 200 is described below in detail with reference to FIGS. 1 to 12. The timepiece 200 is for example a watch, in particular a wristwatch. The timepiece 200 comprises a timepiece movement 100 intended to be mounted in a timepiece casing or case in order to protect it from the external environment. The timepiece movement 100 may be a mechanical movement, notably an automatic movement, or a hybrid movement, or an electronic movement.

In the embodiment shown, the timepiece movement is a mechanical timepiece movement. The timepiece movement comprises a control stem 10, which makes it possible notably to set the time of the timepiece movement. This timepiece movement is provided with a counting device 90. The counting device performs a first timepiece function. The first timepiece function is, for example, counting of the time and display of the time counted, more particularly counting down of the time and display of the time counted down. As a result, the counting device is, for example, of the type which counts down a programmable or adjustable predetermined period of time. The counting device may be a module intended to be fitted to a basic movement or a device incorporated within the basic movement. The counting device comprises a control device provided with a first and a second control member C1, C2, which are notably pushbuttons. These control members (or control means) are, for example, disposed at 4 o'clock and 2 o'clock, respectively.

Moreover, the counting device comprises two display members:
a first, seconds counting mobile 22, for example secured to a seconds hand 22a, and
a second, minutes counting mobile 44, for example secured to a minutes hand 44a.

For example, these first and second mobiles are disposed in the center of the timepiece movement. The seconds hand 22a can interact with a first limb, notably a limb that extends over 360°, enabling a display through 60 seconds. The minutes hand 44a can interact with a second limb, notably a limb that extends over approximately 300°, enabling for example a display of “backward” type, indicating, for example, a maximum duration of 10 minutes.

The second control means C2 (of “start/stop” type) makes it possible to control the starting up and stopping of the counting device. To do this, the second control means C2 makes it possible to actuate a lever 20 capable of actuating a control cam 21, notably a two-cycle column wheel 21, such that each action on the second control means C2 makes it possible to configure the counting device to start up or to stop in alternation. More particularly, the control cam 21 can be disposed respectively:
in a first, “running” or activation position P1, and
in a second, “stop” or deactivation position P2.

The first control means C1 makes it possible to return the mobiles 22, 44 to the starting position, in particular makes it possible to return the first and second counting mobiles to the initial position or to reset them, once the counting device has been stopped. The mobiles and the hands which are secured thereto are thus returned to an initial display state. In this embodiment, the first control means C1 for returning to the starting position also enables a function of correcting the first and second counting mobiles, notably of the “set to the closest minute” type (explained below), when the counting device is running or active.

More advantageously still, after the mobiles 22, 44 have been returned to their respective starting position or their initial position, it is possible to adjust the counting duration by successive actions on the first control means C1, notably by successively pressing on the first control means C1.

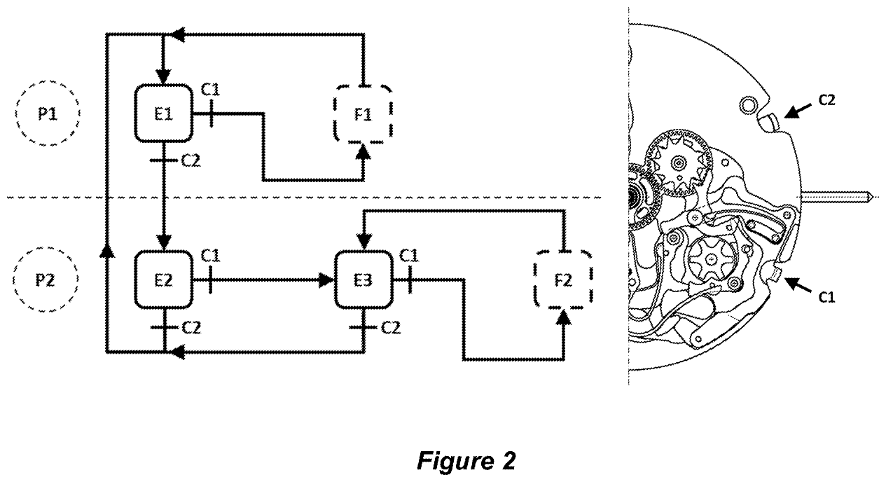

A sequence of the configurations and the functions of the timepiece movement is illustrated in FIG. 2 depending on the various actions carried out on the control device.

In FIG. 2:
the notation C1 illustrates an action on the first control means C1,
the notation C2 illustrates an action on the second control means C2,
the notation P1 illustrates a state in which the control cam 21 is in a configuration in which the counting device is running,
the notation P2 illustrates a state in which the control cam 21 is in a configuration in which the counting device has been stopped,
the notation E1 illustrates a state in which the counting device, or more particularly the first timepiece function, is in a running or activation configuration (activation state),
the notation E2 illustrates a state in which the counting device, or more particularly the first timepiece function, is in a stop or deactivation configuration (deactivation state),
the notation E3 illustrates a state in which the counting device, or more particularly the first timepiece function, is in a configuration of return to the starting position or a resetting configuration (reset state),
the notation F1 illustrates a function of correcting the counting device, or more particularly the first timepiece function, notably of the “set to the closest minute” type, and
the notation F2 illustrates a function of adjusting or programming the counting device.

These various states and functions are explained below.

Correction Function F1 of the “Set to the Closest Minute” Type

The correction function F1 is implemented by actuating the first control means C1 when the counting device is in the running configuration E1.

This function makes it possible to return the seconds mobile 22 and the hand 22a, preferably instantaneously, to the starting position (“0”) while the counting device is in the running configuration E1. The minutes mobile 44 and its hand 44a, for their part, are not returned to their starting position but to the closest full minute of the time in the course of being counted. For example, if there are 2 minutes and 18 seconds left to count down, an action on the first control means C1 makes it possible to reposition the hands of the counting device “on the fly” so that they display 2 minutes and 0 seconds. For example, if there are 2 minutes and 48 seconds left to count down, an action on the first control means C1 makes it possible to reposition the hands of the counting device “on the fly” so that they display 3 minutes and 0 seconds. Like a “flyback” function, this “set to the closest minute” function does not stop the counting mobiles or the hands. The latter resume counting the time as soon as they are reset and possibly as soon as the first control means C1 has been released. As a result, as seen above, the first timepiece function is a chronograph function or a timing function, in particular a countdown function, displaying a first item of information, notably minutes information, and a second item of information, notably seconds information. Furthermore, an action, notably a pressing action, on the first control means C1 while the counting device is in an activation state causes the display of the second information to be returned to the initial position, notably reset to zero, and the display of the first information to be set to the closest full item of information.

Advantageously, this function makes it possible, for example, to synchronize the counting device with a reference countdown “on the fly”, as is necessary, for example, before or upon the start of a regatta.

This function F1 is advantageous for but not indispensable to the operation of the counting device. Because of this, the first control means C1 could simply be inoperative in the running configuration E1 of the counting device.

Adjustment Function F2

The adjustment or programming function F2 is possible by actuating the first control means C1 when the counting device is in the configuration E3 of return to the starting position, that is to say when the counting device has been reset, i.e. when the counting device indicates the initial counting time.

This function enables the programming or adjustment of the number of minutes to be counted down by the counting device. Specifically, in the configuration E3, each action on the first control means C1 makes it possible to move the minutes mobile 44 through a predefined pitch and consequently makes it possible to configure the number of minutes to be counted down by the hand 44a. For example, an action on the first control means C1 makes it possible to change over from a configuration with a time of 1 minute to be counted down to a configuration with a time of 2 minutes to be counted down, and so on. In the embodiment described, an action on the first control means C1 while the counting device is in a configuration with a time of 10 minutes to be counted down brings the minutes hand 44a into a configuration with a time of 0 minutes to be counted down.

Running Configuration E1

In this configuration, the counting device counts down the programmed counting duration. The control cam 21 is in a running position P1.

In this configuration:
an action on the first control means C1 for returning to the starting position makes it possible to actuate the “set to the closest minute” function F1. The counting device remains in the running configuration E1.
An action on the second, “start/stop” control means C2 makes it possible to move the control cam 21 from a running position P1 to a stop position P2, changing the configuration of the counting device from the running configuration E1 to the stop configuration E2.

Stop Configuration E2

In this configuration, the counting device has been stopped. The control cam 21 is in a stop position P2.

In this configuration:
an action on the second, “start/stop” control means C2 makes it possible to move the control cam 21 from a stop position P2 to a running position P1, changing the configuration of the counting device from the stop configuration E2 to the running configuration E1.
An action on the first control means C1 for returning to the starting position makes it possible to change over from the stop configuration E2 to the configuration E3 of return to the starting position that was programmed beforehand.

Configuration E3 of Return to the Starting Position

In this configuration, the counting device is in its starting position that was programmed beforehand. The disposition of the control cam 21 is unchanged in relation to the stop configuration E2. The counting device consequently remains stopped or deactivated in this configuration E3. In other words, in the configuration E3, the counting device is deactivated and returned to the initial position.

In this configuration:
an action on the second, “start/stop” control means C2 makes it possible to move the control cam 21 from a stop position P2 to a running position P1, changing the configuration of the counting device from the configuration E3 of return to the starting position to the running configuration E1.
An action on the first control means C1 makes it possible to actuate the adjustment or programming function F2, thereby possibly modifying the starting position, without modifying the configuration E3.

The operation of the counting device is explained below.

When the counting device is in the running configuration E1, the first, seconds mobile 22 is driven by a geartrain of a basic movement, which is not shown, via a coupling, which is not shown. When the measurement is stopped, the seconds mobile 22 and its seconds hand 22a are decoupled from the geartrain by the coupling and are kept in position, for example by virtue of friction, so as to display the time measured, notably the time counted down. Advantageously, the seconds mobile 22 is provided with a heart-piece, which is not shown, for returning it to the starting position or initial position.

The second, minutes mobile 44 forms part of a geartrain for counting minutes, which makes it possible to connect it kinematically to the first, seconds counting mobile 22 via a unidirectional connection mobile 23. The geartrain for counting minutes moreover comprises (as shown in FIG. 1):
a programming mobile 40,
a mobile 41 for returning to the starting position or resetting mobile,
a cam mobile 42, and
an incrementing mobile 45.

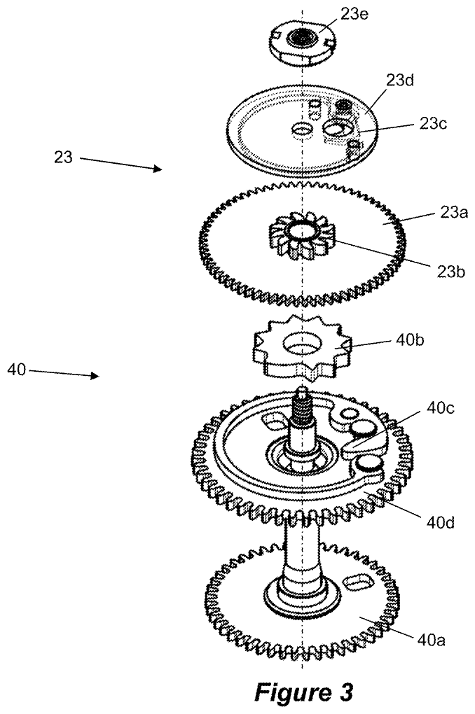

The unidirectional connection mobile 23 makes it possible, under certain conditions (notably upon return of the counting device to the starting position, or upon being “set to the closest minute”), to decouple the minutes wheel 44 and the seconds wheel 22. The mobile 23, which can be seen more particularly in FIG. 3, is provided with a wheel 23a secured to a starwheel 23b. The wheel 23a is kinematically connected to the seconds mobile 22. The starwheel 23b is intended to interact with a pawl 23c providing a unidirectional connection that performs the decoupling function. The pawl 23c is joined to a flange 23d which rotates conjointly with a wheel 40a and a starwheel 40b of the programming mobile 40.

As a result, notably upon return to the starting position, this unidirectional connection mobile 23 makes it possible to independently reposition the hands 22a and 44a of the mobiles 22 and 44, respectively.

The wheel 40a is connected to the mobile 41 for returning to the starting position. More particularly, the wheel 40a meshes with a wheel 41a that rotates conjointly with a cam 41b. The function of the mobile 41 is to make it possible to return the minutes mobile 44 to the starting position under the action of a hammer 32 for returning to the starting position. This hammer will be described in more detail later on.

The starwheel 40b of the programming mobile 40, like the wheel 40a, is able to be driven by the unidirectional connection mobile 23. The starwheel 40b is intended to interact with a pawl 40c arranged on a wheel 40d connected to the minutes mobile 44 via the cam mobile 42.

Advantageously, the programming mobile 40 makes it possible to program the starting position of the minutes mobile 44 before starting up the countdown. The shape of the starwheel 40b and that of the pawl 40c allow the wheel 40a and the wheel 40d, which are connected to the mobile 41 for returning to the starting position and to the minutes mobile 44, respectively, to assume multiple relative angular positions. Each of these positions corresponds to a programmable duration of the countdown that ranges, for example, between 0 and 10 minutes and can, for example, take any integer value comprised between 0 and 10.

As a result, when the counting device is in the configuration E3 of return to the starting position, it is possible to modify the relative angular position of the minutes mobile 44 with respect to that of the mobile 41 for returning to the starting position and thus to program the duration of the countdown.

The cam mobile 42 comprises a wheel 42a disposed at the interface between the wheel 40d and the minutes mobile 44. The wheel 42a is secured to a cam 42b which is snail-shaped. A lever 43, which is elastically returned by an elastic return element 43a, is preferably provided with a runner 43b which interacts with the cam 42b. This interaction allows the mobile 42 to prevent the rotation of the minutes mobile 44 once the time counted down by the countdown has been reached. In other words, in the running configuration E1, when the programmed duration has been counted down, the hand 44a secured to the minutes mobile is at 0 minutes and remains in this position until the counting device is back in the configuration E3 of return to the starting position.

Although the rotation of the minutes mobile 44 is blocked here, it should be noted that the seconds mobile 22 continues to rotate. It is the unidirectional connection mobile 23 which enables this decoupling between the two mobiles.

The incrementing mobile 45 is provided with a starwheel 45b which is secured to a wheel 45a engaged with the minutes mobile 44. The starwheel 45b is able to be actuated by the control device such that the user can modify the relative angular position of the starwheel 40b and of the pawl 40c of the programming mobile 40 and thus the starting position of the hand 44a of the minutes mobile 44. The programming function F2 is thus performed by this mobile 45.

The control device provides a sequence for the function of programming the countdown which is undoubtedly simple and intuitive for the user by virtue of the utilization of the first control means C1 for returning to the starting position. In addition to the first and second control means, the control device mainly comprises:
the lever 20,
the control cam 21,
a control lever 30,
an incrementing pawl 31,
the hammer 32 for returning to the starting position or resetting hammer, and
a locking lever 33.

The first control means C1 makes it possible to actuate the lever 30 that is joined to a frame 50 of the counting device or of the timepiece movement and pivoted about an axis A30. The lever 30 is elastically returned to the initial position by an element which is not shown. The pawl 31 provided with a beak 31c is arranged at a first end of the lever 30. This pawl 31 can pivot relative to the lever 30 about an axis A31. Its beak 31c is able to interact with a toothing 45c of the starwheel 45b of the incrementing mobile 45 when the counting device is in the configuration E3 of return to the starting position. The pawl 31 is more particularly elastically returned by an elastic return element 31a such that it has a tendency to interact with the starwheel 45b.

At a second end of the lever 30, a functional part 30b is able to interact with a first portion 32b of the hammer 32 when the counting device is in the stop configuration E2.

The hammer 32 is mounted so as to be able to pivot relative to the frame 50 about an axis A32. One end of the hammer 32 is intended to interact with the cam 41b of the mobile 41, preferably via a pivoting runner 32d. An elastic return element 32a interacts with the hammer 32 so as to exert a torque on the latter which tends to move the runner 32d out of the range of the cam 41b.

The hammer 32 comprises a second portion 32c able to interact with the control cam 21 when the counting device is in the running configuration E1 or in the stop configuration E2. Moreover, the portion 32c is also able to interact with a portion 33c of a locking lever 33 when the counting device is in the configuration E3 of return to the starting position. In this latter configuration, the hammer 32 is locked in the recess of the cam 41b by the lever 33.

The lever 33 is mounted so as to be able to pivot relative to the frame 50 about an axis A33. Depending on the configuration of the counting device, its angular position with respect to the frame 50 is defined by the interaction of its portion 33c with the portion 32c of the hammer 32 and by the interaction of another portion 33d of the lever 33 with the control cam 21.

The lever 33 is also provided with a portion 33b intended to interact with a functional part 31b of the pawl 31 when the counting device is not in the configuration E3 of return to the starting position, so as to position the beak 31c outside the range of the toothing 45c of the incrementing mobile 45. In other words, with the exception of this latter configuration, the pawl 31 is inoperative.

An elastic return element 33a makes it possible to elastically return the lever 33 such that the portion 33d has a tendency to interact with the control cam 21 and such that the pawl 31 has a tendency to interact with the incrementing mobile 45.

The lever 33 then performs two functions depending on the configuration of the counting device: a function of decoupling the pawl 31 from the incrementing mobile 45 in the running and stop configurations E1, E2 and a function of locking the hammer 32 in the configuration E3 of return to the starting position.

This lever 33 advantageously makes it possible to modify the functioning of the control means C1 between the configurations E1, E2 and the configuration E3.

This is because, in the running and stop configurations E1, E2, the lever 33 keeps the pawl 31 outside the range of the incrementing mobile and allows the hammer 32 to interact with the control cam 21. It is then not possible to program the countdown. The lever 30 makes it possible to return to the starting position when the counting device is in the configuration E2, and enables the “set to the closest minute” function F1 when the counting device is in the configuration E1.

In the configuration E3, the lever 33 keeps the hammer 32 locked in the recess of the cam 41b and releases the pawl 31 such that each action on the first control means C1 therefore makes it possible to actuate the programming function F2.

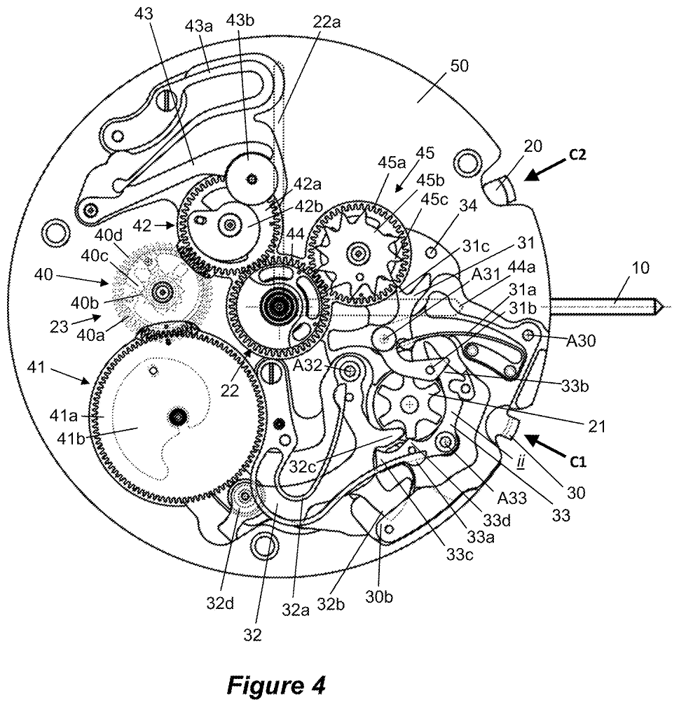

FIG. 4 illustrates the counting device in the running configuration E1, notably at the start of any activation of the device. In other words, the counting device starts to count down a countdown duration that was programmed beforehand.

The control cam 21 is positioned in a running position P1 by the lever 20. In this position, the control cam 21 positions the lever 33 so as to keep the pawl 31 outside the range of the incrementing mobile 45, and the functional part 30b of the lever 30 outside the range of the hammer 32.

More particularly, the portion 33d of the lever 33 bears against a column of the control cam 21. The portion 33b of this lever retains the pawl 31 by way of a pin arranged in its functional part 31b, such that its beak 31c is outside the range of the toothing 45c of the starwheel 45b of the incrementing mobile 45. The hammer 32, pushed back by the elastic return element 32a, is free to disengage completely from the cam 41b of the mobile 41 for returning to the starting position, such that:
its portion 32c falls between two columns of the control cam 21, and
the portion 32b is outside the range of the functional part 30b of the lever 30.

In this configuration, the lever 30 thus cannot act on the hammer 32 or on the incrementing mobile 45.

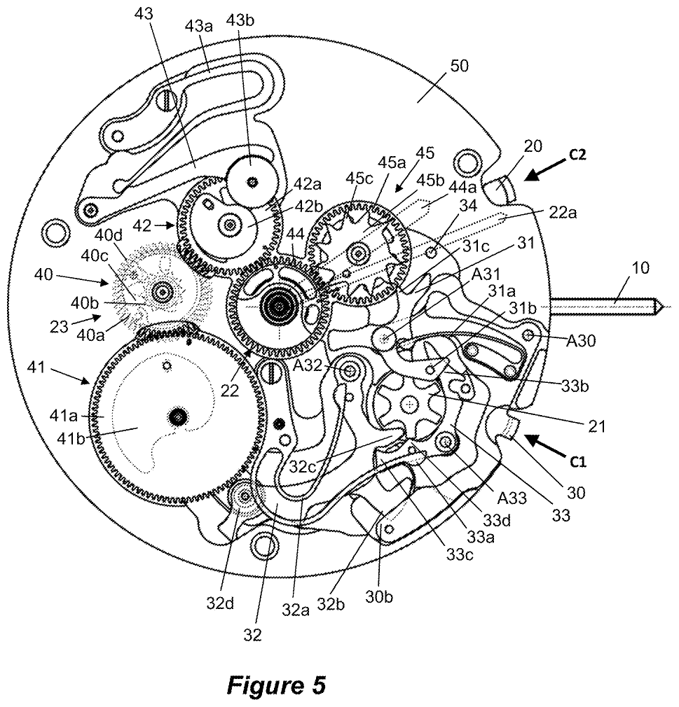

FIG. 5 illustrates a position of the counting device in which the programmed duration is counted down, in other words a running configuration E1 of the counting device. The configuration of the counting device is unchanged in relation to FIG. 4. Only the mobiles 22 and 44 and their respective hand 22a, 44a have been moved in relation to FIG. 4. Specifically, the seconds mobile 22 is driven by the geartrain. The minutes mobile 44 is also driven by the geartrain, but via the unidirectional connection mobile 23, as mentioned above.

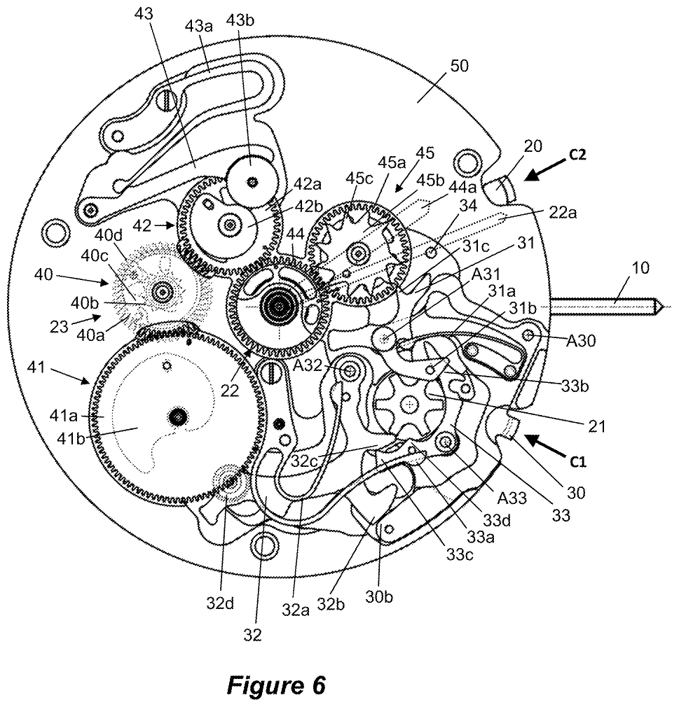

By actuating the second control means C2 in the running configuration E1, the counting device changes over to the stop configuration E2. In this configuration, the control cam 21 has been placed in a stop position P2 by the lever 20 of the control means C2. This configuration is illustrated in FIG. 6. The counting down of the duration stops after the seconds mobile 22 has been decoupled (not illustrated). As a result, all of the geartrain for counting minutes has also stopped.

In this position P2, the portion 32c of the hammer 32 interacts here with one of the columns of the control cam 21 so as to position the hammer 32 such that it can be actuable by the lever 30 of the control means C1. More particularly, in this instance the portion 32b of the hammer is located opposite a pin arranged on the functional part 30b of the lever 30.

The portion 32c in addition makes it possible to keep the lever 33, by way of its portion 33c, in a position for disposing the pawl 31 outside the range of the incrementing mobile 45, as in the configuration E1.

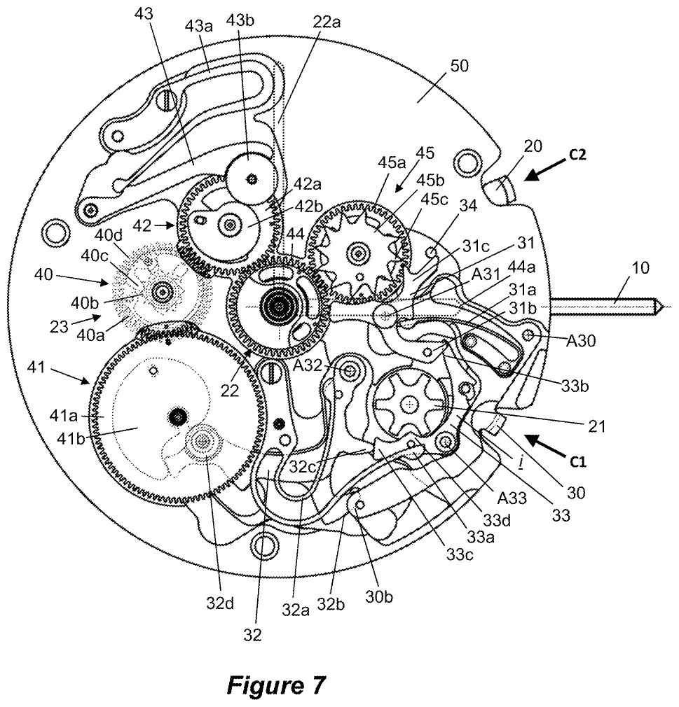

FIG. 7 illustrates the device in the configuration E3 of return to the starting position following the actuation of the control means C1 from the stop configuration E2. In this figure, the first control means C1 is kept pressed down. This makes it possible to better illustrate the position of the various elements of the control device upon return to the starting position. Of course, the lever 30 returns to its initial position after the control means C1 is released.

The seconds and minutes mobiles 22, 44 have been repositioned in their respective starting or initial position.

Given that, in the stop configuration E2, the portion 32b of the hammer 32 has been positioned opposite the functional part 30b of the lever 30, an action on the latter makes it possible to drive the hammer 32 until it reaches the recess of the snail-shaped cam 41b. The mobile 41 is thus in the starting position, driving along with it the minutes mobile 44 via the programming mobile 40 and the cam mobile 42. Upon return to the starting position, the geartrain for counting minutes is advantageously decoupled from the seconds mobile 22 by the unidirectional connection mobile 23, as seen above.

Once the hammer 32 has reached the recess of the cam 41b, the lever 33 is no longer retained by the portion 32c of the hammer and, placed under tension by its elastic return element 33a, pivots so as to release the pawl 31 such that it can interact with the incrementing mobile 45. More particularly, the portion 33d of the lever is positioned between two columns of the control cam 21. The portion 33b releases the functional part 31b of the pawl 31 which is pushed back by its elastic return element 31a such that its beak 31c can interact with the starwheel 45b of the mobile 45.

It should be noted that, in order to avoid any malfunction caused by contact being made between the beak 31c and the starwheel 45b during the return to the starting position, the pawl 31 is temporarily retained by a stop 34 arranged on the frame 50. However, this stop is not indispensable to the operation of the control device.

Moreover, the lever 33 is positioned between the two columns of the control cam. In this position, the portion 33c makes it possible to keep the hammer 32, by way of its portion 32c, in the recess of the cam 41b. This holding in place makes it possible, on the one hand, to separate the lever 30 from the hammer 32 and advantageously for the rotation of the mobile 41 to remain blocked, thereby making it possible to program the countdown duration. This point is explained in more detail below.

In a variant, the portion 33c can retain the hammer 32, by way of its portion 32c, with slight play. Because of this, once the first control means C1 has been released, a slight play is brought about between the hammer 32 and the recess of the cam 41b. However, the rotation of the mobile 41 remains blocked with very little play.

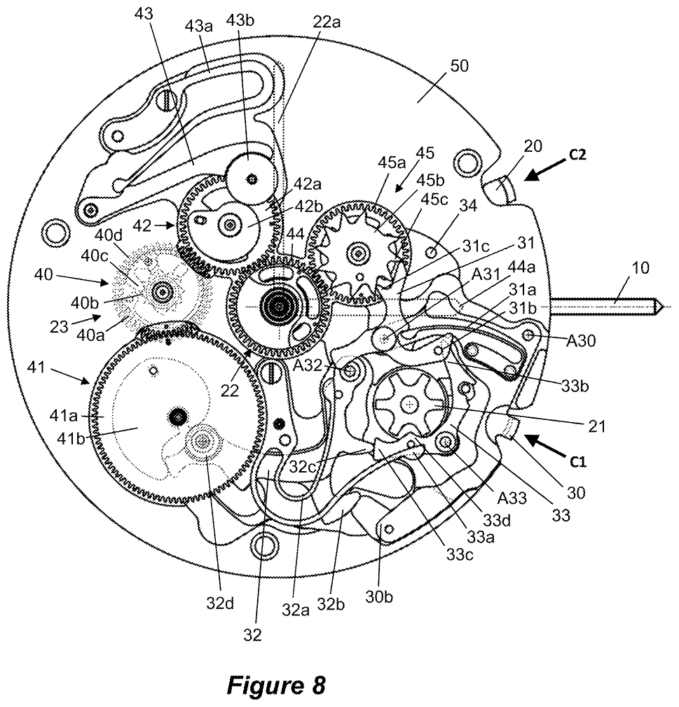

FIG. 8 illustrates the counting device at rest in the configuration E3 of return to the starting position, that is to say the reset position. In relation to the previous figure, the first control means C1 has been released. This configuration can be reached only after the device has been in the stop configuration E2.

Once the configuration E3 of return to the starting position has been reached and the first control means C1 has been released, it is possible to program the countdown duration by successive actions on this same first control means C1.

Indeed, it will be noted that the functional part 30b is outside the range of the hammer 32 and that an action on the control means C1 would then not have an effect on the hammer.

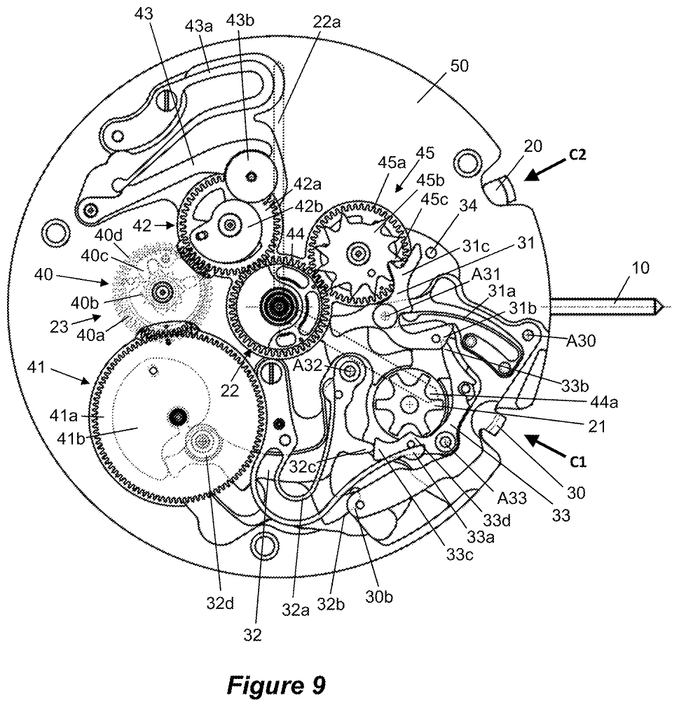

By contrast, the beak 31c of the pawl 31 is now engaged in the toothing 45c of the starwheel 45b, as shown in FIG. 8. Therefore, each action on the control means C1 makes it possible to pivot the lever 30 with its pawl 31 so as to cause the starwheel 45b to advance by one pitch. This programming action is for example illustrated in FIG. 9.

When the mobile 45 is incremented by one pitch, it drives along with it the minutes mobile 44, which moves to the next minute, and the cam mobile 42 and the wheel 40d of the programming mobile 40. The starwheel 40b, which is kinematically connected to the wheel 40a and to the mobile 41 for returning to the starting position, is advantageously prevented from rotating by the interaction of the hammer 32 with the latter. This prevention allows the pawl 40c and the wheel 40d to be disposed in a new angular position with respect to the starwheel 40b. Consequently, the minutes mobile 44 can assume a new relative angular position in relation to the starting position of the mobile 41. This is how a new countdown duration is programmed.

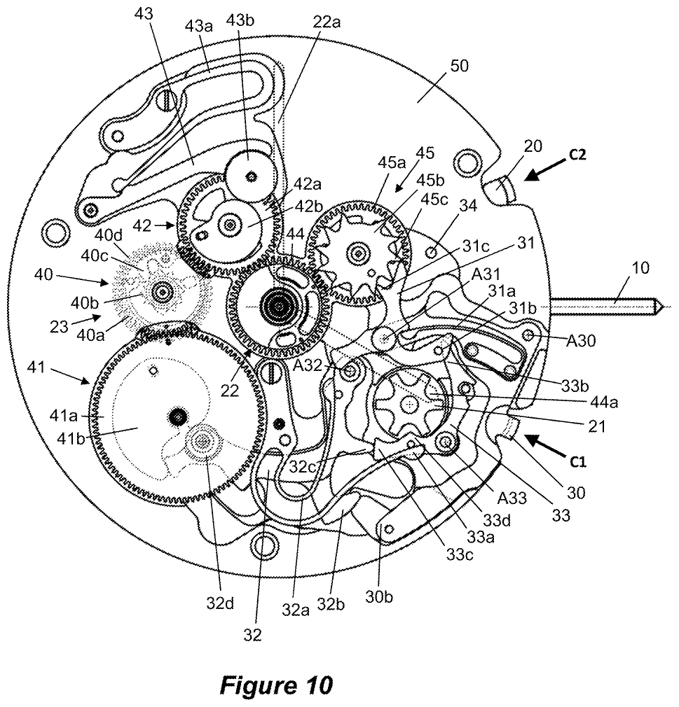

FIG. 10 illustrates the return of the lever 30 to the initial position after the aforementioned action.

Once the configuration E3 has been reached, it is possible to indefinitely actuate the first control means C1, by successively pressing on it, to perform an action or actions for adjusting the function. The minutes mobile 44 can thus indefinitely sweep all of the programmable range, in the present instance from 0 to 10 minutes. The modification is sequential and/or incremental, specifically preferably for each pitch of one unit. The sequence can thus be 0, 1, 2, 3, 4, 5, 6, 7, 8, 9, 10, 0, 1, 2, etc. As a result, the adjusting action is an incremental and/or sequential action.

To start a new countdown, all that is required is to actuate the second control means C2, which makes it possible to reposition the control cam in a running position P1 and allows the counting device to go back to the running configuration E1 described above and illustrated in FIG. 4.

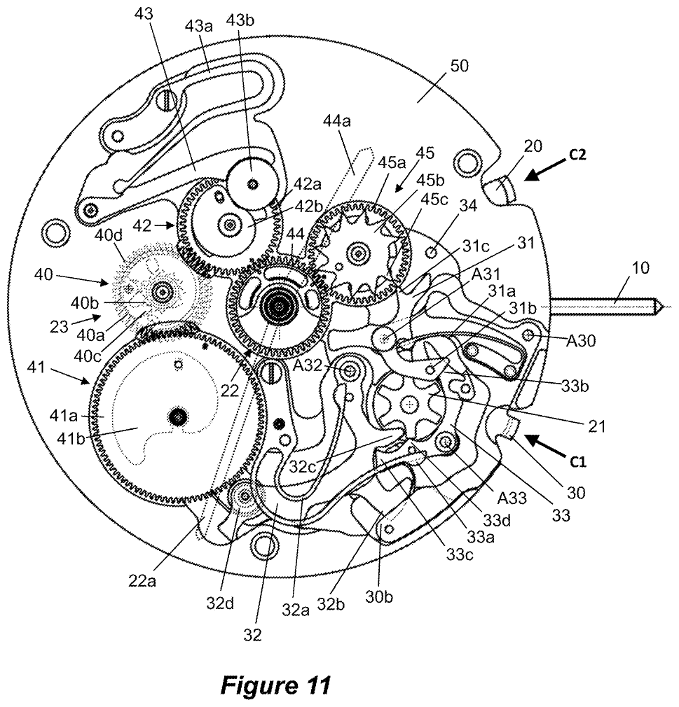

FIG. 11 illustrates the counting device in the running configuration E1 at the end of a programmed countdown. The minutes mobile 44 is thus stopped at 0 minutes, whereas the seconds mobile 22 continues to rotate. The mobile is more particularly blocked by the runner 43b, which has entered the recess of the snail-shaped cam 42b of the mobile 42. Therefore, the geartrain for counting minutes is decoupled from the seconds mobile 22 by the unidirectional connection mobile 23, as seen above.

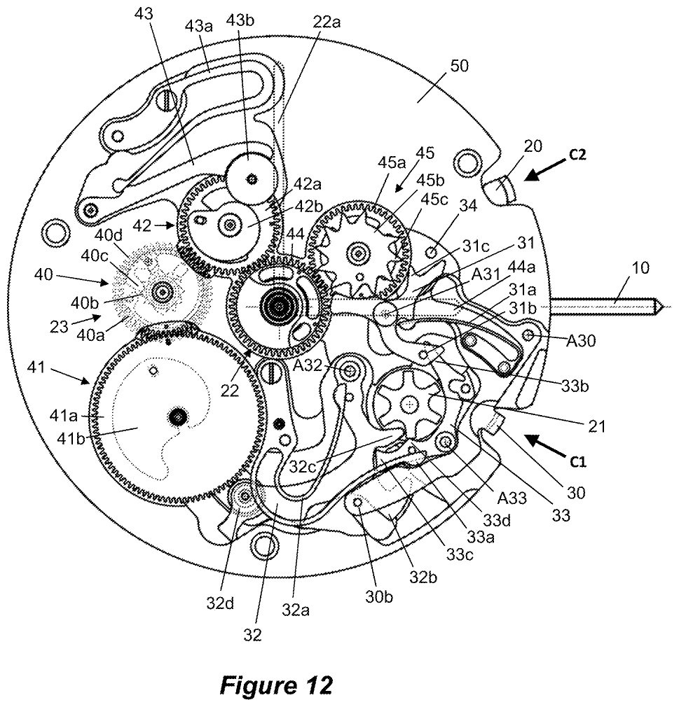

FIG. 12 illustrates the actuation of the first control means C1 for returning to the starting position, whereas the counting device is in the running configuration E1. As mentioned above, in this configuration, the lever 30 does not have an effect on the mobile 41 for returning to the starting position and the incrementing mobile 45. However, like a “flyback” function, it makes it possible to instantaneously position the seconds mobile 22 and needle 22a in a starting position by virtue of an action on a dedicated heart-piece for returning to the starting position, which heart-piece is not shown. As the minutes mobile 44 is kinematically connected to the seconds mobile 22, the return of the latter to the starting position causes the minutes mobile 44 and needle 44a to be repositioned to the nearest minute of the countdown.

The embodiment shown is based on a mechanism with two pushbuttons that is provided with a two-cycle control cam (column wheel with twice as many teeth as columns). In a variant, the column wheel may be replaced by a device having one or more cams or shuttles. More generally, any other binary and/or bistable device can be utilized.

Irrespective of the embodiment or the variant, the counting device may be a chronograph device.

Irrespective of the embodiment or the variant, the adjustment ensured by the first control means C1 can serve another function such as, for example, the adjustment of the duration of a decompression dive for a diver. The first control means C1 can also serve another function that is different than that which forms part of the counting device.

Specifically, irrespective of the embodiment or the variant, the first control means C1 can be used for any adjustment of the watch that can be done using a pushbutton, for example incremental adjustment of a calendar, of a jumping hour, etc. The first control means C1 can even be used, for example, to wind an energy accumulation device, such as a barrel intended for a chronograph geartrain, an alarm barrel, etc.

Consequently, it will be understood that it is possible for the incrementing mobile not to form part of the counting device and that it could be connected to a kinematic chain that is not contained in the counting device, in connection with a second timepiece function.

For example, a first action on the first control means C1 would bring about a return to an initial state of display or a reset of a countdown, and then at least one second action on the first control means C1 would bring about winding of an alarm barrel intended to cause an alarm mechanism to sound by unwinding at the end of the countdown.

It is apparent from the above explanations that one embodiment of a method for operating the counting device 90 or the timepiece movement 100 or the timepiece 200 comprises:
a first action on the first control means C1 causing the first timepiece function to be returned to an initial state of display or reset, and then
a second action on the first control means C1 causing an action of adjusting a second timepiece function. This adjusting action assumes that the first timepiece function has been returned to an initial state, that is to say that the first function is in an initial position and has been stopped.

In the embodiment described in detail, the first action is a user firstly pressing on the first control means C1, notably pressing on a pushbutton C1, and/or the second action is secondly pressing on the first control means C1, notably by a user pressing on the pushbutton C1. The actions of pressing on the pushbutton preferably include a pressing phase as such, and then a phase of releasing the pushbutton, in which the pushbutton is returned to its initial rest position. During the release phase, it is possible for the pushbutton not to have an effect on the counting device, that is to say it is possible for the pushbutton not to exert any mechanical action modifying a state of a component of the counting device.

Preferably, between the first action and the second action, it is not necessary to exert any action on the counting device for the second action to have a different result than the first action, that is to say that it is not necessary to exert any action in order to modify the configuration or the state of the counting device. Also preferably, between the first action and the second action, it is not necessary to exert any action on any user interface (pushbutton, crown, stem, rotating bezel, lever, bolt, trigger-piece, pull-out piece, knurling-roller) of the timepiece for the second action to have a different result than the first action. Preferably, between the first action and the second action, it is not necessary to exert any action on the second control means C2.

In other words, between the first action and the second action, it is not necessary for the user to exert any action on the timepiece in order to modify the function of the first control means C1.

Consequently, the method is advantageously implemented without the user exerting any action on the timepiece, notably without the user exerting any action on a user interface of the timepiece, between the first action and the second action.

Advantageously, the first timepiece function and the second timepiece function are one and the same timepiece function. More advantageously still, the first function is a chronograph function or a timing function, in particular a countdown function.

Preferably, any second action on the first control means C1 while the first timepiece function is in an initial state causes an action of adjusting the second timepiece function.

Advantageously, third actions, notably third pressing actions, on the second control means C2 cause the counting device, and therefore the first timepiece function, to be sequentially activated and deactivated.

Preferably, the counting device is arranged and/or configured such that the first action on the first control means C1 causes:
the control lever 30 to pivot,
the pivoting of the control lever causing the hammer 32 to act on the mobile 41 for returning to the starting position, notably by the hammer 32 pivoting,
the hammer 32 releasing the locking lever 33 such that the locking lever 33 is placed in a position (i) (visible in FIG. 7):
   of locking the hammer in a position in which it interacts with the mobile 41 for returning to the starting position, and
   of releasing the incrementing pawl 31.

Preferably, the counting device is arranged and/or configured such that the second action on the first control means C1 causes:
the control lever 30 to pivot,
the control lever causing the incrementing pawl 31 to move in such a way that the latter interacts with the incrementing mobile 45 in order to make said incrementing mobile rotate by one pitch.

Preferably, the counting device is arranged and/or configured such that, while the first timepiece function is in an initial or reset state, the third action on the second control means C2 causes:
the control cam 21, notably the column wheel 21, to rotate by one pitch,
the rotation of the control cam 21 causing the locking lever 33 to pivot such that the latter is placed in a position (ii) (visible in FIG. 4) in which it unlocks the hammer 32 and deactivates the incrementing pawl 31,
the unlocking of the hammer 32 causing the hammer to return to a position in which it does not interact with the mobile for returning to the starting position.

Third actions exerted sequentially cause the first timepiece function to be activated and deactivated in succession.

As a result of what has been described above, the lever 30 is arranged and/or configured so as to:
have a receiving portion for the action of the first control means C1,
make it possible to pivot the incrementing pawl 31,
have a portion 30b intended to act on the hammer 32, and
have a portion intended to act directly or indirectly on a heart-piece for returning the first mobile 22 to the initial state.

As a result of what has been described above, the hammer 32 is arranged and/or configured so as to:
have a portion 32d intended to act on the cam 41b of the mobile 41 for returning to the starting position,
have a portion 32b intended to receive the action of the lever 30,
have a portion 32c intended to interact with the control cam 21 so as to place or not place the hammer in a position in which the lever 30 can act on the hammer,
have a portion 32c intended to interact with the locking cam 33 so as to lock the hammer 32 in a position in which it acts on the cam 41b of the mobile 41 for returning to the starting position, and
have a portion for receiving the action of an elastic return element 32a.

As a result of what has been described above, the locking lever 33 is arranged and/or configured so as to:
have a portion 33d intended to interact with the control cam 21 so as to position the locking lever 33,
have a portion 33c intended to interact with the hammer 32 so as to notably lock the hammer 32 in a position in which it acts on the cam 41b of the mobile 41 for returning to the starting position, and
have a portion 33b intended to interact with the incrementing pawl 31 so as to prevent it from acting on the incrementing mobile 45.

In the embodiment described, a second action on the first control means C1 causes an action of adjusting the second timepiece function. As an alternative, a second action on the first control means C1 can cause:
an action of winding the second timepiece function, or
an action of performing the second timepiece function (if this second timepiece function differs from the first timepiece function).

The winding action causes deformation of a spring, the energy of which is ultimately used to perform the second timepiece function.

The proposed solutions make it possible to program the countdown by using a control means for returning to the starting position or a resetting control means.

Advantageously, these solutions provide a particular sequence for the control means, which makes it possible to program the counting device after the display of the latter has been returned to the starting position or reset. More particularly, once the counting device has been reset, the control means makes it possible to incrementally program the number of minutes to be counted down for the next countdown, without it being necessary for the user to actuate another control means or interface means in order to activate the programming function.

These solutions thus greatly simplify the handling required to program a counting device, such as a countdown device, by proposing an intuitive sequence. In addition, the solutions make it possible to propose a device which does not require additional control means.

Unless specified otherwise, in the present document, ordinal numeral adjectives (“first”, “second”, “third”, etc.) have a distinctive meaning and not a temporal meaning.

1. A method of operating a counting device, the method comprising:
performing a first action on a first control member causing a first timepiece function to be returned to an initial state, and then
performing a second action on the first control member causing an action of adjusting or winding a second timepiece function.

2. The method as claimed in claim 1, wherein the first timepiece function and the second timepiece function are a single timepiece function.

3. The method as claimed in claim 1, wherein the first function is a timing function or a chronograph function.

4. The method as claimed in claim 1, wherein the adjusting or winding action is an incremental and/or sequential action.

5. The method as claimed in claim 1, wherein any second action on the first control member while the first timepiece function is returned to an initial state causes an action of adjusting or winding the second timepiece function.

6. The method as claimed in claim 1, wherein the first action is a pressing action on the first control member and/or wherein the second action is a pressing action on the first control member.

7. The method as claimed in claim 1, wherein third actions on a second control member cause the first timepiece function to be sequentially activated and deactivated.

8. The method as claimed in claim 1, wherein the first timepiece function is a chronograph function displaying a first item of information and a second item of information, and wherein a fourth action on the first control member while the first timepiece function is in an activation state causes a display of the second item of information to return to an initial state and a display of the first information to be set to a closest full item of information.

9. The method as claimed in claim 1, wherein the first action causes:
a control lever to pivot,
pivoting of the control lever causing a hammer to act on a mobile for returning to a starting position, and
the hammer releasing a locking lever so that the locking lever is placed in a locking position locking the hammer in interacting position in which the hammer interacts with the mobile for returning to the starting position and releases an incrementing pawl.

10. The method as claimed in claim 9, wherein the second action causes:
the control lever to pivot,
the control lever causing the incrementing pawl to move so that the incrementing pawl interacts with an incrementing mobile in order to make the incrementing mobile rotate by one pitch.

11. The method as claimed in claim 9, wherein a third action on a second control member cause the first timepiece function to be sequentially activated and deactivated, and wherein, while the first timepiece function is in an initial state, the third action causes:
a control cam to rotate by one pitch,
rotation of the control cam causing the locking lever to pivot so that the locking lever is placed in an unlocking position in which the locking lever unlocks the hammer and deactivates the incrementing pawl,
unlocking of the hammer causing the hammer to return to a non-interacting position in which the hammer does not interact with the incrementing mobile for returning to the starting position.

12. A counting device comprising hardware arranged and configured to implement the method as claimed in claim 1.

13. The counting device as claimed in claim 12, wherein the hardware comprise:
a first control member,
a second control member,
a control cam,
an incrementing pawl,
a hammer,
a locking lever,
a mobile for returning to the starting position, and
an incrementing mobile.

14. The counting device as claimed in claim 13, wherein the hardware comprise a control lever and wherein the first control member interacts with the control lever, the control lever being able to act on the hammer and on the incrementing pawl and/or wherein the second control member is arranged so as to act on the control cam.

15. A timepiece comprising the counting device as claimed in claim 12.

16. The method as claimed in claim 1, wherein the counting device is part of a timepiece movement.

17. The method as claimed in claim 1, wherein the counting device is a countdown device.

18. The method as claimed in claim 17, wherein the first function is a countdown function.

19. The method as claimed in claim 7, wherein the third actions are pressing actions.

20. The method as claimed in claim 8, wherein the first timepiece function is a countdown function and the first item of information is minutes information and the second item of information is seconds information, and wherein the fourth action is a fourth pressing action.
